(19) United States
(12) Patent Application Publication
(10) Pub. No.: US 2025/0113396 A1
(43) Pub. Date: Apr. 3, 2025

(54) METHODS AND DEVICES FOR DATA TRANSMISSION FROM USER EQUIPMENT

(71) Applicant: Sony Group Corporation, Tokyo (JP)

(72) Inventors: Torgny PALENIUS, Barsebäck (SE); Lars NORD, Lund (SE)

(21) Appl. No.: 18/726,326

(22) PCT Filed: Dec. 21, 2022
(86) PCT No.: PCT/EP2022/087234

§ 371 Date: Jul. 2, 2024

(30) Foreign Application Priority Data
Jan. 20, 2022 (SE) 2250050-8

(51) Int. Cl. H04W 76/14; H04W 74/06; H04W 74/0833; H04W 76/11; H04W 88/04

(52) U.S. Cl. CPC H04W 76/14; H04W 74/06; H04W 74/0833; H04W 76/11; H04W 88/04

(57) ABSTRACT

A method carried out in a User Equipment (10), UE, for transmission of data to a wireless network (100), the method comprising: receiving (412) a poll message (41) from a relay device (20), which poll message identifies a request for data transmission to the wireless network: transmitting (414) a Non-Access Stratum, NAS, message (42) in response to the poll message, said NAS message comprising a protocol data unit, PDU, including the data, and a temporary ID for the UE to address a core network node in the wireless network, wherein the relay device is instructed to forward the NAS message to the wireless network.

### TECHNICAL FIELD

This disclosure is related to wireless communication between a wireless device and a wireless network. Specifically, solutions are provided for managing uplink transmission of data from a wireless device, in particular a passive wireless device configured to transmit responsive to receiving radio-frequency energy.

### BACKGROUND

Various protocols and technical requirements for wireless communication have been standardized under supervision of inter alia the 3rd Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication.

Every UE needs to be powered in some way to be able to communicate with the wireless network. Regardless of the capability of the UE, energy conservation is a relevant factor to consider. One clear development that can be identified in the evolving character of the specifications which provide regulations and guidelines for wireless communication, is the implementation of a larger variety of types of UEs, including less complex UEs, and related simplified, constrained, or relaxed regulations with regard to communication configurations associated with such less complex UEs. This can be seen as part of an evolution towards an Internet of Things (IoT) context, where a vast amount of connectable UEs and UE types are conceivable, some of which may be configured only for simple communications tasks, such as to occasionally report a measured value of a certain parameter. For at least some types, such UEs may be expected to be able to operate for very long periods of time without needing a battery recharge or replacement, in particular for UE types being configured for long periods of inactivity between scarce and short communication instances.

Related to this context, it has been proposed that 3GPP wireless networks shall support passive IoT devices that harvest energy to perform UL transmission. This may e.g. include backscattering type of communication for low cost devices similar to RFID (radio-frequency identification) tags. Backscattering is when the “transmitter” in the device uses the downlink (DL) carrier wave for both energy harvesting and uplink (UL) transmission by reflecting the carrier back after modulating the carrier with the UL data. There are also other types of RFID devices. The commonality between these devices is the extreme power and energy constrains. If these devices are to be 3GPP devices i.e. User Equipment (UE), then the 3GPP system overhead needs to be addressed and optimized.

### SUMMARY

In view of the foregoing, it is an objective to present a solution for handling UEs in a wireless network, which solution is configured to take low energy and power constraints on the UEs into consideration. An aspect of this objective is to provide a solution which allows for UL transmission of data from such UEs in a manner that is sustainable from an energy consumption perspective, in particular for passive UEs which are configured to transmit in UL only in response to DL reception.

The proposed solution, which targets these objectives, is set out in the independent claims, whereas various examples thereof are set out in the dependent claims and in the following detailed description.

According to a first aspect, a method carried out in a UE is provided for transmission of data to a wireless network, the method comprising:
receiving a poll message from a relay device, which poll message identifies a request for data transmission to the wireless network;
transmitting a Non-Access Stratum, NAS, message in response to the poll message, said NAS message comprising a protocol data unit, PDU, including the data, and a temporary ID for the UE to address a core network node in the wireless network, wherein the relay device is instructed to forward the NAS message to the wireless network.

According to a second aspect, a method carried out in a relay device is provided, for conveying data from a UE to a wireless network, the method comprising:
transmitting a poll message, which poll message identifies a request for data transmission to the wireless network;
receiving, in response to the poll message, a Non-Access Stratum, NAS, message from the UE, wherein the NAS, message comprises a protocol data unit, PDU, including the data, and a temporary ID for the UE to address a core network node in the wireless network; and
transmitting, based on an indication to forward the NAS message, a signaling packet comprising the NAS message to the wireless network.

By means of the presented solution, a proposal for data upload from a UE is provided, where the uplink transmission is carried out over a relay device which polls the UE. Specifically, a data transmission process is provided which does not require active PDU sessions, and where the relay device remains ignorant of the data it forwards and the NAS message as such. The only active steps carried out by the relay device is to identify that the received NAS message is to be forwarded, and subsequently transmit the signaling packet comprising the NAS message for reception in the access node. The access node will resolve where to forward the NAS message, e.g. to which AMF. The proposed solution is particularly beneficial for energy-conservative UL transmission from passive UEs, which require reception of radio-frequency (RF) energy to transmit.

### BRIEF DESCRIPTION THE DRAWINGS

FIG. 1 schematically illustrates an implementation of a wireless communication system, in which a UE communicates with a wireless network by radio communication over a relay device.

FIG. 2A schematically illustrates a network node configured to operate in the wireless network for communication with the UE according to various examples.

FIG. 2B schematically illustrates a UE configured to operate with the wireless network according to various examples.

FIG. 2C schematically illustrates a relay device configured to operate with the UE according to various examples.

FIG. 3 illustrates an example of a particular kind of passive type UE according to FIG. 2B, configured to operate by harvesting radio-frequency energy from a received wireless signal, to process and transmit in the uplink by reflecting the bearer.

FIG. 4A illustrates a signaling diagram, identifying various aspects of the proposed solution.

FIG. 4B illustrates a signaling diagram, identifying various aspects related to registering a UE to a wireless network, according to various examples of the proposed solution.

FIG. 5A illustrates a signaling diagram, identifying aspects of various examples of the proposed solution related to configuration of temporary IDs for use in communication between the UE and the wireless network.

FIG. 5B illustrates a signaling diagram, identifying various aspects of the proposed solution of FIG. 5A, modified with added features related to security handling.

### DETAILED DESCRIPTION

In the following description, for the purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof. The terms “receive” or “receiving” data or information shall be understood as “detecting, from a received signal”.

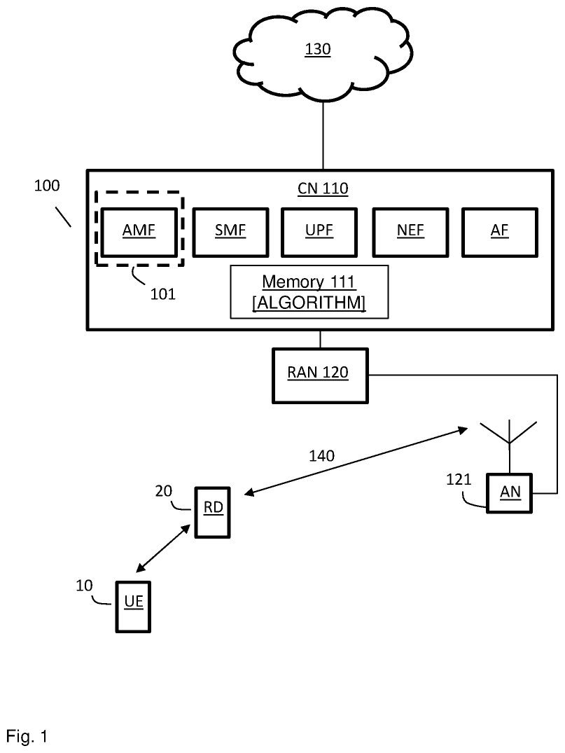

FIG. 1 illustrates a high-level perspective of operation of a UE 10 in a wireless system, configured to communicate with a wireless communication network 100, denoted wireless network 100 for short herein. The wireless network 100 may be a radio communication network 100, configured to operate under the provisions of 5G as specified by 3GPP, according to various examples. The wireless network 100 may comprise a core network (CN) 110, connectable to an external network 130 such as the Internet. The core network may comprise a plurality of core network nodes, which realize logical functions. For the example of a 5G system, as illustrated, this may inter alia include the Access and Mobility Management Function (AMF), a Session Management Function (SMF), a User Plane Function (UPF), a Network Exposure Function (NEF), and an Application Function (AF), all of which are legacy functions of the 5G system. The AF(s) may also be deployed outside of the 5G system i.e. as an application running on an application server connected to the external network e.g. the Internet.

The core network 110 is connected to at least one access network 120 comprising one or more base stations or access nodes, of which one access nodes 121 is illustrated. The access node 121 is a radio node configured for wireless communication on a physical channel 140 with various UEs, such as the relay device 20. The physical channel 140 may be used for setting up one or more logical channels between UEs and the wireless network, such as with the AMF.

Before discussing further details and aspects of the proposed method, functional elements for examples of the entities involved in carrying out the proposed solution will be briefly discussed, including the UE 10, the relay device 20, and a network node 101 of the wireless network 100.

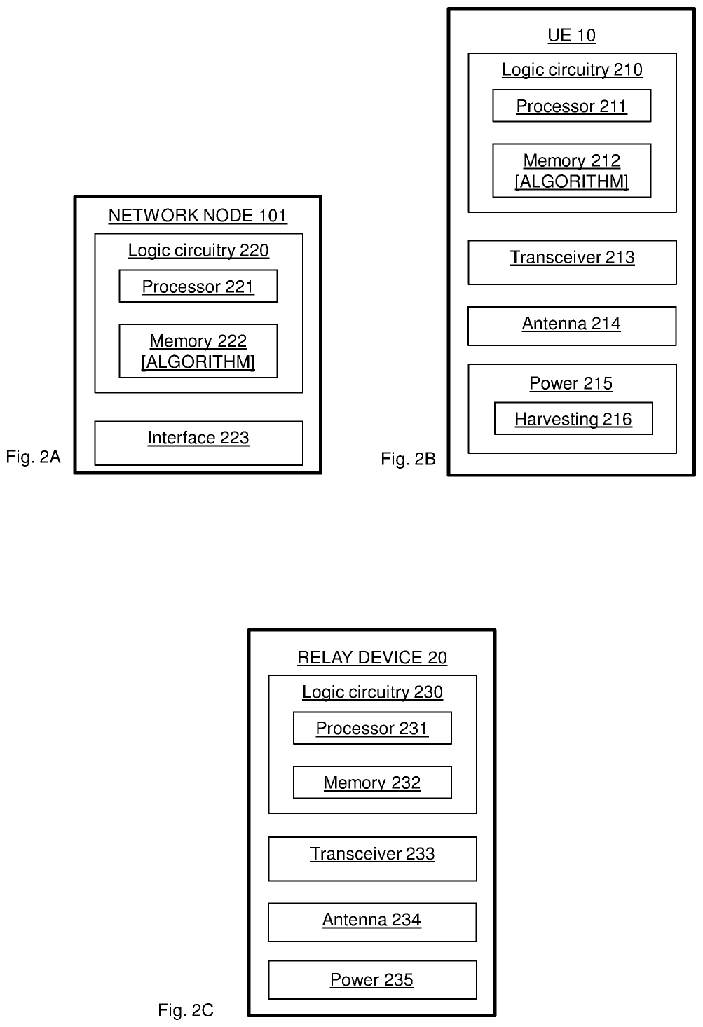

FIG. 2A schematically illustrates an example of a network node 101 of the wireless network 100 as presented herein, and for carrying out various method steps as outlined. The network node 101 may in some examples realize the logical function of the AMF.

The network node 101 comprises an interface 223 for communicating with other entities of the radio communication network 100, such as other entities of the core network 110. The interface 223 is further configured for communication with UEs over the access network 120.

The network node 101 further comprises logic circuitry 220 configured to control communication via the interface 223, and in various examples configured to carry out tasks associated with the AMF. The logic circuitry 210 may include a processing device 221, including one or multiple processors, microprocessors, data processors, co-processors, and/or some other type of component that interprets and/or executes instructions and/or data. The processing device 221 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 220 may further include memory storage 222, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the network node 101 to carry out any of the method steps as provided herein. Software defined by said computer program code may include an application or a program that provides a function and/or a process. The software may include device firmware, an operating system (OS), or a variety of applications that may execute in the logic circuitry 210.

FIG. 2B schematically illustrates an example of the UE 10 for use in a wireless network 100 as presented herein, and for carrying out various method steps as outlined. Some relevant elements or functions of the UE 10 are shown in the drawing. The UE 10 may however include other features and elements than those shown in the drawing or described herein, such as a casing, a user interface, sensors, etc., but these are left out for the sake of simplicity.

The UE 10 comprises a radio transceiver 213 for communicating with other entities of the radio communication network 100, such as the access node 121 or the relay device 20, in one or more frequency bands. The transceiver 213 may thus include a receiver chain (Rx) and a transmitter chain (Tx), for communicating through at least an air interface.

The UE 10 may further comprise an antenna system 214, which may include one or more antennas, antenna ports or antenna arrays. In various examples the UE 10 is configured to operate with a single beam, wherein the antenna system 214 is configured to provide an isotropic gain to transmit radio signals. In other examples, the antenna system 214 may comprise a plurality of antennas for operation of different beams in transmission and/or reception. The antenna system 214 may comprise different antenna ports, to which the Rx and the Tx, respectively, may selectively be connected. For this purpose, the antenna system 214 may comprise an antenna switch.

The UE 10 further comprises logic circuitry 210 configured to communicate data and control signals, via the radio transceiver, on a physical channel 140 to a serving access node 121 of the wireless network 100. The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

The UE 10 further comprises a power supply 215 that provides energy to the other components of the UE 10. In some examples, the power supply 215 may comprise a battery. The battery 215 may be non-replaceable, and even non-chargeable, in various embodiment of low complexity UE types.

In yet another example, the power supply is configured to harvest incoming radio-frequency (RF) energy, which is used to power the other components of the UE 10, so as to enable certain processing and UL transmission.

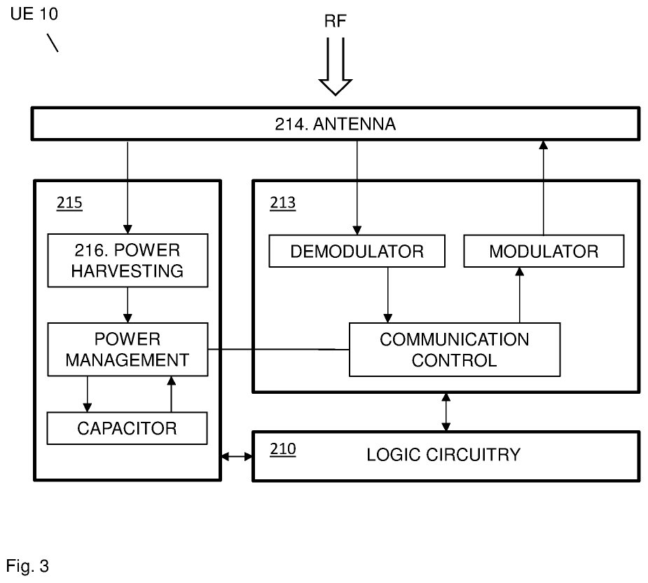

FIG. 3 provides a schematic overview of such an example, usable in the UE 10, wherein the UE 10 may be configured as a passive IoT device that harvests energy to perform UL transmission. The UE 10 may thus be configured to employ so-called backscatter communication, similar to RFID tags. Backscattering is when the transceiver 213 in the UE 10 uses the DL carrier wave, noted as RF in the drawing, for both energy harvesting and using it for UL transmission by reflecting the carrier back after modulating the carrier with the UL data. Same reference numerals as used in FIG. 2B are shown in FIG. 3, although the functional elements are differently realized. In this context, and using the logical representation provided in FIG. 3, the power supply 215 may comprise a power harvesting circuit 216, connected to the antenna 214, a power management module and a capacitor, such as a supercapacitor. The transceiver 213 may comprise a communication control module, which is powered by the power management module. The communication control module may be connected to a demodulator for demodulating an incoming RF signal, and to a modulator for subsequently modulating an outgoing. “reflected”, RF signal. The logic circuitry 210, comprising a processor 211 and memory 212, is likewise energized by the power management module and connected to control operation of the at least the transceiver 213.

There are also other types of UEs, including other types of RFID device types, having high or extreme energy and power constraints in common. The inventors have thus identified that system overhead needs to be addressed and optimized, in view of UEs operating under such high power constraints, such as various types of UEs operating under 3GPP specifications, e.g. one or more types of 5G UEs. In the context of such UEs which are configured to operate under severe energy constraints, e.g. only capable of transmitting in response to receiving RF energy or other external energy stimulus, or which otherwise are configured to only transmit in response to a received trigger, operation of the UE may be entirely under the control of an application function or application server associated with the UE.

In order to support energy conservation in the UE 10, in particular when the UE 10 is a passive UE such as in the example of FIG. 3, it is here proposed that UL transmission of data be handled via a relay device 20. This may facilitate successful UL transmission with a limited output power of the UE 10, since closer proximity to the relay device 20 may be obtained than to an access node 121.

In the prior art, one way to maintain good coverage is to utilize UE based relays via the so-called sidelink communication channel. Sidelink based communication is feasible for cellular communications with limited coverage or no coverage from the 3GPP network. In some scenarios one UE can act as a relay for another UE, relaying information to and from e.g., an access node. This has been developed to support coverage for UEs that are out of coverage by relaying the data to the network. In sidelink relay, the remote UE, the UE 10 in this case, is in RRC connected state with the network 100, using an established PDU session on which it communicates data. Such prior art procedure may even include establishment of a security protocol. Furthermore, there is an adaption layer protocol that encapsulates the remote UE's message until it reaches the access node.

However, for UEs operating under energy and power limited conditions, such as passive UEs, it is herein proposed that the UE 10 shall be capable of just sending a limited amount of data, or just an ID, for instance in order to identify an item on which the UE 10 is fastened. It is therefore important that the UE 10 can send a very limited amount of data to another wireless device which in an efficient way, to save power for the wireless device acting as relay and to limit the delay, sends this data to the network. FIG. 2C schematically illustrates an example of the wireless device 20, such as a UE in the context of 3GPP terminology, which operates as a relay device 20 in the context of the proposed solution. The relay device 20 may be a stationary or mobile device, such as a handheld device, and is configured for use in a wireless network 100 and for carrying out various method steps as outlined. Some relevant elements or functions of the relay device 20 are shown in the drawing. The relay device 20 may however include other features and elements than those shown in the drawing or described herein, such as a casing, a user interface, sensors, etc., but these are left out for the sake of simplicity.

The relay device 20 comprises a radio transceiver 233 for communicating with other entities of the radio communication network 100, such as the access node 121, in one or more frequency bands. The transceiver 233 may thus include a receiver chain (Rx) and a transmitter chain (Tx), for communicating through at least an air interface.

The relay device 20 may further comprise an antenna system 234, which may include one or more antennas, antenna ports or antenna arrays. In various examples the relay device 20 is configured to operate with a single beam, wherein the antenna system 234 is configured to provide an isotropic gain to transmit radio signals. In other examples, the antenna system 234 may comprise a plurality of antennas for operation of different beams in transmission and/or reception. The antenna system 234 may comprise different antenna ports, to which the Rx and the Tx, respectively, may selectively be connected. For this purpose, the antenna system 234 may comprise an antenna switch.

The relay device 20 further comprises logic circuitry 230 configured to communicate data and control signals, via the radio transceiver, on a physical channel 140 to a serving access node 123 of the wireless network 100. The logic circuitry 230 may include a processing device 231, including one or multiple processors, microprocessors, data processors, co-processors, and/or some other type of component that interprets and/or executes instructions and/or data. The processing device 231 may be implemented as hardware (e.g., a microprocessor, etc.) or a combination of hardware and software (e.g., a system-on-chip (SoC), an application-specific integrated circuit (ASIC), etc.). The processing device 231 may be configured to perform one or multiple operations based on an operating system and/or various applications or programs.

The logic circuitry 230 may further include memory storage 232, which may include one or multiple memories and/or one or multiple other types of storage mediums. For example, the memory storage 232 may include a random access memory (RAM), a dynamic random access memory (DRAM), a cache, a read only memory (ROM), a programmable read only memory (PROM), flash memory, and/or some other type of memory. The memory storage 232 may include a hard disk (e.g., a magnetic disk, an optical disk, a magneto-optic disk, a solid state disk, etc.). The memory storage 232 is configured for holding computer program code, which may be executed by the processing device 231, wherein the logic circuitry 230 is configured to control the relay device 20 to carry out any of the method steps as provided herein. Software defined by said computer program code may include an application or a program that provides a function and/or a process. The software may include device firmware, an operating system (OS), or a variety of applications that may execute in the logic circuitry 230.

The relay device 20 further comprises a power supply 235 that provides energy to the other components of the relay device 20.

According to the proposed solution, the UE 10 sends a message in direct communication to a UE 20 with Relay capability, referred to herein as a relay device 20, wherein the relay device 20 is instructed to forward the message to the wireless network 100. The UE is registered in the network 100 and has a locally stored temporary ID usable for communicating with the wireless network 100. Further details on various examples for obtaining the temporary ID and registering in the wireless network 100 will be provided below. In case of passive UE 10, such as when operating in backscatter mode, the relay device 20 starts the interaction with the UE 10 with a “power” signal to provide for energy harvesting in the UE 10. The power signal may carry a poll message sent by the relay device 20 or be transmitted shortly prior to the poll message. In response to the poll message, the UE 10 transmits a Non-Access Stratum, NAS, message, comprising a protocol data unit, PDU, including data to be uploaded, and its temporary ID.

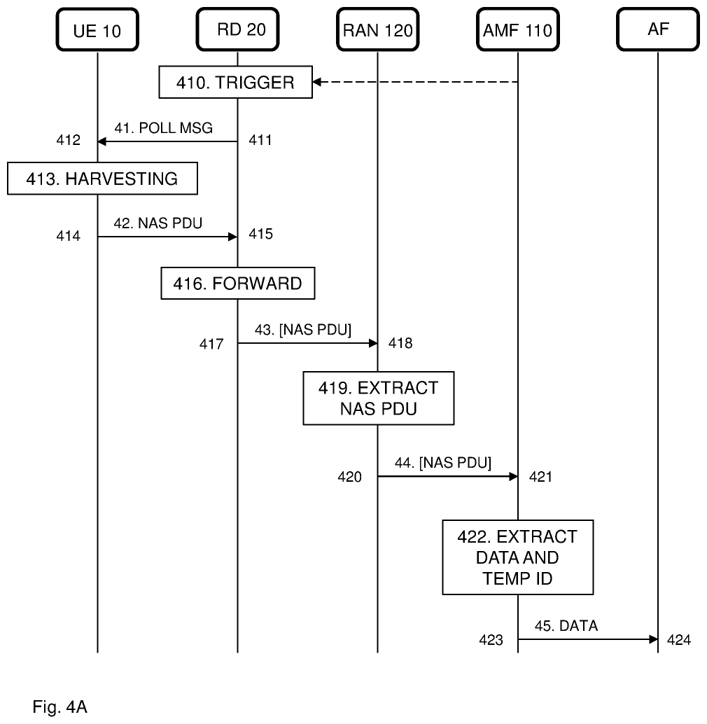

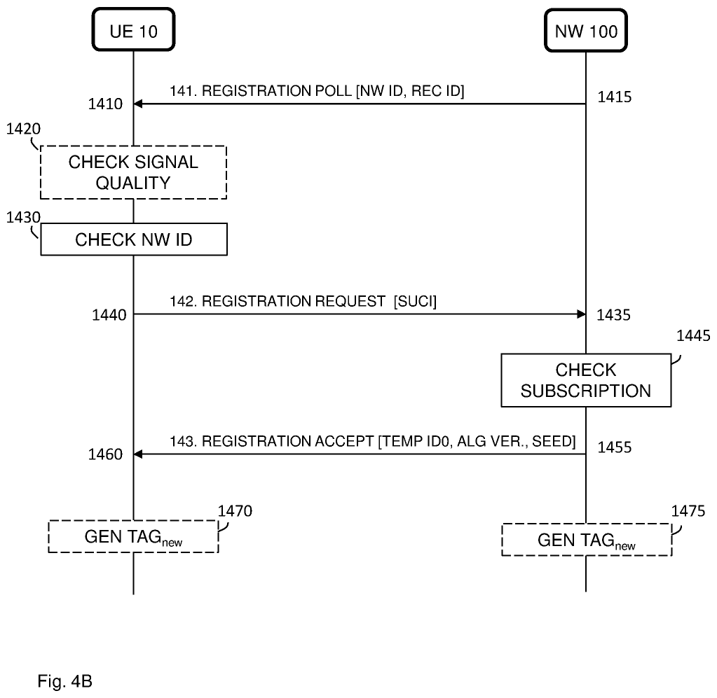

FIG. 4A shows a signaling diagram which illustrates various method steps carried out according to different examples of the proposed solution.

From the aspect of the UE 10, the proposed solution comprises a method for transmission of data to the wireless network 100, the method comprising:

receiving 412 a poll message 41 from a relay device 20, which poll message identifies a request for data transmission to the wireless network;

transmitting 414 a NAS message 42 in response to the poll message, said NAS message comprising a PDU including the data, and a temporary ID for the UE to address a core network node in the wireless network, wherein the relay device is instructed to forward the NAS message to the wireless network.

The UE 10 configured to carry out this method may comprise a wireless transceiver 213, and logic circuitry 210 configured to control the UE to carry out the outlined steps.

From the aspect of the relay device 20, the proposed solution comprises a method for conveying data from a UE 10 to a wireless network 100, the method comprising:

transmitting 411 a poll message, which poll message identifies a request for data transmission to the wireless network;

receiving 415, in response to the poll message, a Non-Access Stratum, NAS, message from the UE, wherein the NAS, message comprises a protocol data unit, PDU, including the data, and a temporary ID for the UE to address a core network node in the wireless network; and

transmitting (417), based on an indication to forward the NAS message, the NAS message to the wireless network.

The wireless device 20, configured to carry out this method to act as a relay device, comprises a wireless transceiver 233, and logic circuitry 230 configured to control the wireless device 20 to operate as a relay device according to the outlined steps.

A benefit with the proposed solution is that neither the UE 10 nor the relay device 20 need to have PDU sessions with the network 100 and can thereby stay in idle state, where applicable. There is no need for the relay device 20 to track or determine which UE 10 sends the small data. In some examples, the UE 10 sends a NAS message, comprising a PDU, to the relay device 20 on a sidelink interface, so-called PC5, with an indication that it shall be forwarded to the wireless network 100. The relay device 20, if in idle state, may thereby be configured to send the NAS message to the wireless network 100 on the signaling radio bearer for RRC messages e.g. SRB0 or SRB1, wherein the relay device 20 transmits the NAS message as small data on the random access channel. The receiving access node 121 will then just forward the NAS PDU to the AMF which discovers the sender and the data packet, in the same way as if it were an EDT/SDT from the relay device 20. Hence, neither the relay device 20 nor the access node 121 need to track or know from which UE 10 the data was sent. The relay device 20 is only provided with the indication that the NAS PDU shall be forwarded to the access network 120, and the subsequently receiving access node 121 needs to determine to which core network node, typically an AMF, to forward the NAS PDU. There may be several AMFs in the wireless network 100, and the access network 120 will know to which AMF to forward the NAS PDU based on the temporary ID associated with the UE. According to some examples, which are described further below, a portion GUAMI (Globally Unique AMF ID) of the temporary ID identifies the AMF. The temporary ID is in one example comprised in the NAS message but sent in clear text, which enables the access node 121 to read it.

In some examples, the temporary ID is provided as a so-called GUTI (Globally Unique Temporary UE Identity) or the 5G-S-TMSI which is a shortened version of 5G-GUTI. The 5G-GUTI is compiled by two parts, the GUAMI and the 5G-TMSI (Temporary Mobile Subscriber Identity). As indicated, the GUAMI is the address of the AMF holding the UE context and the 5G-TMSI is a UE identification created in the AMF. In other examples, the temporary ID comprises only the 5G-TMSI, wherein the RAN 120 determines the associated GUAMI. In further examples, which will be outlined in greater detail below, the temporary ID comprises at least a portion which is locally generated by an algorithm in the UE 10, while the same algorithm is stored in memory 111 in the wireless network 100. This way, successive temporary IDs may be generated locally in the UE 10 and in the wireless network 100, with reduced signaling. With reference to FIG. 4A, various examples related to the proposed solution will be outlined.

A session of data transmission from the UE 10 to the wireless network 100 may include the relay device 20 sending a polling 41 for data. This may comprise sending a discovery signal including RF energy for harvesting and reusing by the UE 10.

Transmission 411 of the poll message 41 may be triggered 410 by an event, such as by an application or by manual input. Alternatively, a periodic trigger may exist, to repetitively transmit the poll message 411. In some examples, the poll message 41 originates from an application in the relay device 20, which triggers the transmission 411. In other examples, the poll message 41 may originate from an application (AF) in the network 100, which requests the AMF to trigger (40) a transmission of a poll message 41. The relay device may in some examples be handled by an operator triggering the transmission of the poll message 41, similar to a handheld RFID reader, such as by manual input. Alternatively, the relay device 20 may be a fixed/stationary device in an environment of UEs, such as UE 10, triggered to transmit the poll message 41. As an example, the relay device 20 may be a user operated or remotely controlled wireless device, configured to transmit the poll message 41 for receipt in such UEs, which UEs may be tags attached to various goods or devices, such as in a store or warehouse.

In some examples, the poll message 41 comprises a recipient ID, identifying said UE, such that the UE is selectively triggered to send a NAS message 42 in response. In various examples, the recipient ID comprises said temporary ID. In other examples, the recipient ID indicates a UE group or UE type to which the said UE belongs. By checking the recipient ID, in the UE 10 with a stored value identifying one or more groups or types of UEs to which the UE 10 belongs, the UE 10 may determine whether or not to respond.

Upon receiving the poll message 41, and the associated RF energy, the UE 10 may be configured to harvest 413 the received RF energy. The UE 10 may in some examples be configured to transmit 414 the NAS message 42 on a carrier reflection of a carrier conveying the poll message 41. This may be obtained by harvesting 413 RF energy obtained upon receiving the poll message 41 and transmitting 414 the NAS message 42 using the harvested energy.

In some examples, the poll message 41 configures the UE 10 to transmit unspecified data. This may for instance be the case where the UE 10 is a low complexity device, configured to store or collect only one type of data. In other examples, the poll message 41 may indicate a type of data to be transmitted. The data may e.g. be measured sensor data obtained in the UE 10, or simply an ID associated with either the UE 10 as such or an item to which the UE 10 is attached.

The UE 10 transmits 414 its data in the NAS message 42 comprising the PDU to the relay device 20 together with an indication of the identity of the UE 10, such as its temporary ID in the wireless network 100. In some examples, the PDU contains data in the same format as when sending a small data packet to the wireless network 100 in EDT (early data transmission) in LTE or SDT (small data transmission) in NR.

When the relay device 20 receives 415 the NAS message 42 from the UE 10, the relay device 20 will make a forwarding determination 416, based on an indication transmitted with the NAS message 42 that it shall be forwarded to the wireless network 100 (which will occur via the RAN 120). The indication is in some examples a forwarding indicator, provided as a bit or flag in the NAS message 42 carrying the NAS PDU, either within the NAS PDU message format or outside the actual NAS PDU message format. In another example, the indication that the NAS message shall be forwarded is simply a determination, made in the relay device 20, that the NAS message 42 is identified as a response to the poll message 41. The forwarding determination 416, based on the indication, identifies that the relay device 20 does not need to encapsulate the forwarded message in an “adaption layer protocol” as L2 Relay does in 3GPP Rel-17.

Since there is no data radio bearer (DRB) for the UE 10, the relay device 20 transmits 417 the NAS PDU including the temporary ID of the UE 10 as a signaling packet 43 to RAN 120 (RRC). The transmission 417 of this signaling packet 43 may be carried out on any signaling bearer from the Relay UE to the RAN 120, e.g. the access node 121, and the transmission 417 is executed without any handling of the temporary ID of the UE 10 in the relay device 20. In one example, if the relay device 20 is in an idle state, the signaling packet 43 is transmitted 417 on its SRB0 as small data (EDT or SDT) to the RAN 120. In some examples, the signaling packet 43 is transmitted on the random access channel, RACH, such as for instance in message 3 of a 4-step RACH process, or in message A of a 2-step RACH process.

A radio resource control, RRC, function in RAN 120 receives 418 the signaling packet 43 and extracts 419 the NAS PDU and forwards it to the AMF, as in DoNAS (Data over NAS). The RAN node 121 does not need to be aware of that the data is received from a remote UE 10 via a relay device 20. Based on the temporary ID of the UE 10, as received 418 with the NAS PDU, the RAN sends 420 the NAS message 44 including the data from the UE 10 to the AMF associated with the temporary ID.

The AMF receives 421 the NAS message 44 originating from the UE 10 and handles it as in DoNAS using the temporary ID. The AMF extracts the data and the temporary ID, but otherwise has no knowledge that the NAS PDU 44 has been received via a relay device 20. The AMF subsequently forwards 423 the data 45 to the application function (AF) associated with the data, where the data is received 424.

According to various examples of the proposed solution, the UE 10 is registered to the wireless network 100, specifically to the Public Land Mobile Network (PLMN) of the wireless network 100, and thereby holds a temporary ID within the PLMN.

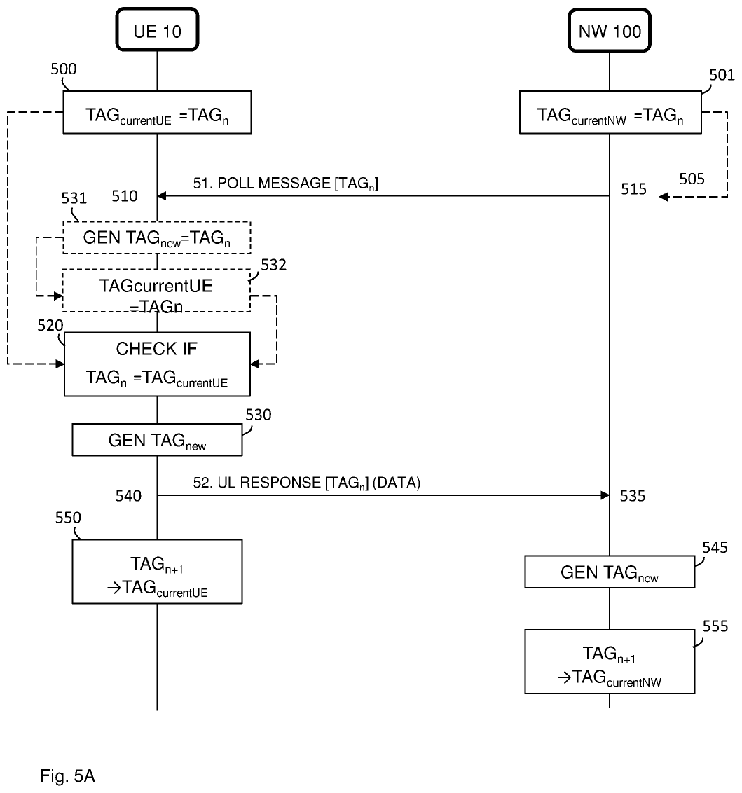

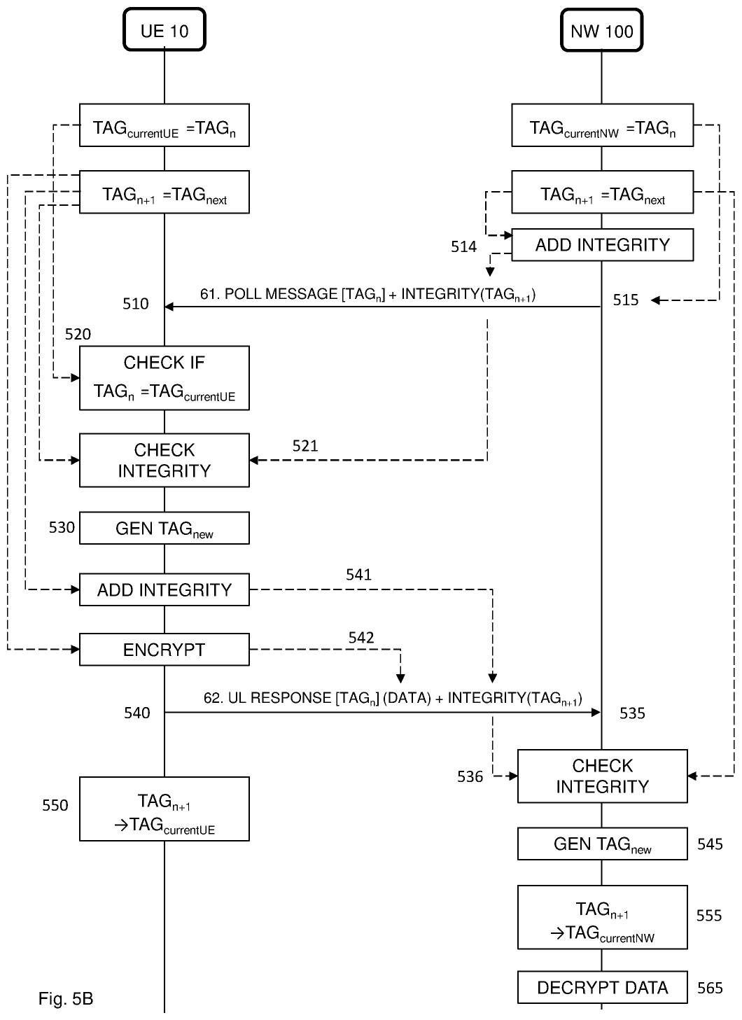

Various examples related to a process for registering the UE 10 to the wireless network will described below. This relates both to initial registration and/or re-registration due to mobility to and roaming in a visited network. It shall be noted that while FIGS. 4B and FIGS. 5A and 5B do not indicate operation over a relay device 20, the processes described with reference to those examples may also be carried out over the relay device 20 in DL and/or UL.

In legacy 3GPP operation, the UE is turned on and the UE starts to search for an allowed PLMN (Public Land Mobile Network) and a suitable cell to start the initial registration procedure. A UE configured to transmit responsive to a received signal, such as a passive IoT type UE, will not do any of these steps. Moreover, it cannot be assumed that the wireless network has any knowledge of the whereabout of the UE. Therefore, a new process for registering such UEs is proposed, whereby the wireless network can find and trigger an unregistered UE to register in the network.

FIG. 4B illustrates a signaling diagram highlighting various steps and actions comprised in a method according to various examples of the proposed solution. The drawing depicts signaling between the UE 10 and the wireless network 100. In this context, it may be noted that the acts carried out in the wireless network 100 may be operated by, or under control of, a network node 101 of the wireless network 100, such as the AMF. Wireless communication, indicated by the horizontal arrows, will be carried out over the access network 120. In various examples, such signaling is carried out by NAS, Non-Access Stratum, signaling.

From the aspect of the wireless network 100, and with reference to FIG. 4B, a method is provided for registering UEs to the wireless network. The method comprises:

transmitting 1415 a poll message 141 configured to trigger UEs to register, said poll message comprising an ID of the wireless network;

determining 1445, responsive to receiving 1435 a registration request message from the UE in response to the poll message, a network subscription based on a subscription ID obtained in the response message; and

transmitting 1455, responsive to the determining identifying a valid network subscription, a registration accept message 143 and a temporary ID assigned to the UE.

From the aspect of the UE 10, a method is provided for registering to the wireless network 100. The method comprises:

receiving 1410 a poll message 141 configured to trigger the UE to register, said poll message comprising an ID of the wireless network;

transmitting 1440, in response to the poll message, a registration request message 142 comprising a subscription ID associated with the ID of the wireless network; and receiving 1460 a registration accept message 143 and a temporary ID assigned to the UE.

Various examples associated with these methods will be described below.

In some examples, the UE 10 is configured to transmit responsive to receiving RF energy in conjunction with receiving the poll message. The request message 142 may in such an example be transmitted on a carrier reflection of a carrier conveying the registration poll message 141, modulated to comprise the subscription ID. The UE 10 may be configured to harvest RF energy obtained upon receiving the poll message 141, use the harvested energy to modulate and reflect the carrier to provide the registration request message 142.

An example of a process according to FIG. 4B will now be described, in which various features and alternative configurations will be outlined.

The wireless network 100 polls 1415 UEs in order to get them registered. This may involve broadcasting 1415 the poll message 141. In some examples, the wireless network is configured to broadcast the poll message 141 to trigger registration in specific cells. This may be determined based on network strategy. E.g., the poll message 141 may be broadcast more frequently in border cells to other networks, or at locations where unregistered UEs are likely to enter coverage of the wireless network 100, such as at airports, ports, etc.

The objective of the poll message may be to specifically obtain registration of UEs that are configured to require an external trigger to transmit. This may involve passive type UEs, as described. In some examples, this may involve UEs configured to operate as an accessory to another associated UE. In such an example, the UE 10 may be configured to communicate with the associated UE over a different wireless protocol, whereas the associated UE is controlled to convey signaling to and from the wireless network 100. In such example, the associated UE takes no logical role in the registration process. The associated UE only relays the signaling messages between the UE 10 and the Network 100, it shall be noted that these signaling messages may or may not be security protected.

In some examples, the poll message 141 is periodically transmitted, to repeatedly provide the opportunity for UEs to get registered. The periodic transmission 1415 may be carried out with a certain interval which may be specified or configured by the wireless network 100. In some examples, the poll message 141 has a long period/interval, such as more than 1 minute or more than 1 hour. In such examples, the registration poll message 141 will consume very little radio resources overall, in the time domain.

The poll message 141 is a generic poll, in the sense that the wireless network 100 typically does not have any information about unregistered UEs present within its coverage area, e.g. no information on UE IDs. In some examples, the network node 101 is configured to provide a recipient ID, REC ID in the poll message 141, identifying a UE group. The REC ID may be specific, or even unspecific to identify all/any UE. In some examples, REC ID is configured to identify UEs of a certain type, such as “all passive type UEs”, meaning any UE requiring an external trigger to transmit. In some examples, REC ID may identify a group by subscription ID range, by company issuing the UE, by network slice, etc.

The poll message 141 further comprises an ID of the wireless network, NW ID. In some examples, the NW ID comprises or uniquely identifies a PLMN ID associated with the wireless network 100.

As noted, the poll message 141 is configured to trigger the UE 10 to register. In some examples this is identified by the poll message 141 comprising a registration poll type indicator REG. In another example, the REC ID may be configured to identify the poll message as a trigger to register. In yet another example, the poll message 141 is identifiable as a trigger for the UE 10 to register by the poll message being transmitted in a predetermined radio resource, or on a carrier with a predetermined carrier frequency, preconfigured for this purpose and thus known to the UE 10.

Upon receiving the poll message 141, the UE 10 may be configured to check the NW ID, such as to verify whether or not the associated PLMN ID is an allowed PLMN for the UE 10.

The UE 10 is configured to transmit 1440 the registration request message 142 in response to the poll message 141, and potentially on the condition that the NW ID identifies an allowed network. The registration request message 142 comprises a subscription ID associated with the NW ID.

In some examples, the UE 10 is configured to determine 1420 a signal quality associated with the poll message 141. The signal quality may e.g. be a received signal strength or a level of quality, assessed with respect to a threshold value in the UE 10. In such examples, the UE 10 may be configured to transmit the registration request message 142 based on the determined signal quality meeting a threshold criterion.

In this context, it may be the case that for certain types of UEs, such as passive UEs, limited coverage is supported. For instance, a certain amount of received energy is required to be able to transmit, and/or a certain limited maximum transmit power is only achievable for transmission due to regulatory or implementation restrictions. For this reason, the UE may be within a certain proximity to the receiver of the transmitted signal 142. Here, the receiver may be an access node 121 of the wireless network 100, or an associated UE to which the UE 10 is communicatively related, as explained above.

In some examples of the suggested solution, the UE 10 may thus be preconfigured to determine 1420 the signal quality (e.g. signal strength) of the poll message 141 before determining to transmit the registration request message 142. This may e.g. mean that the UE 10, receiving repeated registration poll messages 141, decides to respond with the registration request message 142 when the received signal is sufficiently good, e.g. when a certain signal strength is determined. Such a scenario may occur when the UE 10 passes an area where there is a transmitter/receiver supporting the polling of the UE 10, such as an access node 121, a repeater or distributed unit (DU) with IAB (Integrated Access Backhaul).

The registration request message 142 will trigger the wireless network 100 to continue the registration procedure. In some examples, the wireless network 100 is configured to continue transmitting an RF power signal responsive to receiving 1435 the registration request message 142, so the UE 10 can harvest energy from the RF signal. On the other hand, if there is no response obtained based on the registration poll message 141, the wireless network 100 can end this process and wait for the next periodic registration check.

It may be noted that for a low-complexity type UE 10, such as a UE operating by energy harvesting, only parts of the parameters requested upon legacy registration in 5G may be of interest. This may in particular be the case for a passive type UE, e.g. operating by backscatter communication. Legacy registration and security mode configuration includes many steps and involves interchange of several parameters and advanced algorithms, e.g. for ciphering and integrity protection. A passive UE only powered by the received RF signal may not have these kinds of capabilities. However, it is very important for system that all UEs are identifiable, trusted, and possible to charge per use. The registration request message 142 comprises at least a subscription ID. In some examples, the subscription ID is SUPI (5G globally unique Subscription Permanent Identifier), or SUCI (encoded SUPI) which is a secure ID calculated as in 3GPP technical specification TS 33.501 v17.4.0. In some examples, the registration request message 142 may further comprise “Preferred Network behavior”=send data over NAS (DoNAS), Non-Access Stratum, and an identification of UE type, such as passive type, RFID type, backscatter type, etc. (which may implicitly point to the “Preferred Network behavior and Security method”. The registration request message 142 may further indicate a security method.

In step 1445 the wireless network 100 checks whether the UE 10, as identified by the subscription ID, has a valid subscription. In some examples this may involve checking Unified data management (UDM), or in a roaming case check with the Home PLMN, HPLMN.

Responsive to identifying a valid network subscription in the check 1445, a registration accept message 143 is transmitted. The registration accept message 143 also identifies the received subscription ID, e.g. SUCI.

After registration is accepted the UE 10 must have a temporary ID which is used for further interactions both for DL and UL interactions. An initial temporary ID: TEMP ID0 is therefore transmitted from the wireless network 100 to the UE 10 in the registration accept message 143. The UE 10 receives 1460 the registration accept message 143 with TEMP ID0, to be used in further interactions between the wireless network 100 and the UE 10.

In some examples, the registration process as described herein further comprises configuring further determination of temporary IDs for use in subsequent interactions between the wireless network 100 and the UE 10. Such further configuration of temporary IDs may be arranged to take into consideration that a UE 10 may be a passive UE, which only transmits in response to a received signal. Based on this consideration, further determination of temporary IDs may be based on local generation of successive temporary IDs in both the UE 10 and in the wireless network 100 according to a negotiated rule, once registration is accomplished. In such examples, the registration process described with reference to FIG. 4B may further comprise negotiating an algorithm version (ALG VER) for use to generate temporary IDs, and initiating a start of temporary ID generation by providing a seed (SEED) for use as input in the algorithm. When the initial temporary ID TEMP ID0, provided with the registration accept message 143, has been used in a communication step between the UE 10 and the wireless network 100, a next temporary ID will be determined by generating 1470, 1475 a new temporary ID using the seed as input to the negotiated algorithm version, both in the wireless network 100 and in the UE 10. This way, these entities will have common awareness of what the next temporary ID will be, without requiring extensive communication and handshaking to determine each new temporary ID.

In some examples, the process therefore comprises transmitting 1455, from the wireless network 100 to the UE 10, a seed for use in a specific algorithm in the UE to iteratively generate a next temporary ID for use in communication with the wireless network, and transmitting an identification of said algorithm. In some examples, as indicated in FIG. 4B, the seed and/or identification of the algorithm is comprised in the registration accept message 143. In an alternative example, the negotiation of the algorithm and the transmission of the seed is accomplished in an additional DL transmission subsequent to the registration accept message 143.

According to one aspect, the proposed solution addresses aspects related to temporary ID handling upon and after UE registration. Legacy 3GPP procedures provide for the use of temporary identities, or temporary IDs, for use in communication between the wireless network and the UE. One objective thereof is to maintain anonymity of the UE in communication signaling. An example is the Globally Unique Temporary UE Identity (GUTI). The purpose of the GUTI is to provide an unambiguous identification of the UE that does not reveal the UE or the user's permanent identity. It also allows the identification of the entity or function within the wireless network which manages the connection of the UE. It can be used by the network and the UE to establish the UE's identity during signaling between them. The GUTI typically has two main components: one that uniquely identifies the managing entity which allocates the GUTI, and one that uniquely identifies the UE managed by that managing entity. In legacy 5G, the temporary ID, the 5G-GUTI is compiled by two parts, the GUAMI (Globally Unique AMF ID) and the 5G-TMSI (Temporary Mobile

Subscriber Identity). The GUAMI is the address of the AMF that is holding the UE context and the 5G-TMSI is a UE identification created in the AMF:

<5G-GUTI>=<GUAMI><5G-TMSI>

In the context of a UE type configured to operate under severe energy constraints, such as a passive type UE configured to harvest DL RF energy, as outlined above, various solutions are described herein for handling temporary IDs. Moreover, associated security methods (integrity and ciphering) will be described, which will reduce signaling compared to legacy 3GPP 5G-TMSI and 3GPP security methods. According to the solutions proposed herein, a different approach is launched, wherein the temporary ID is instead created locally, both within the UE 10 and in the wireless network 100. This way, overhead caused by transmission occasions for the purpose of determining the next temporary ID are eliminated, thus saving at least one DL transmission and one UL transmission. The algorithm may be configured to iteratively generate temporary IDs. Rather than the wireless network transmitting the new temporary ID, the algorithm will be iterated in one or more steps according to a known rule to generate a new temporary ID, which is known both in the UE 10 and in the wireless network 100, on account of the same algorithm being used. A new temporary ID, here called 5GTAG-GUTI by way of example, is suggested to replace the 5G-GUTI used in legacy. The new temporary ID is in some examples still compiled by two parts, the GUAMI and an iterated part TAG-TMSI (instead of 5G-TMSI):

<5GTAG-GUTI>=<GUAMI><TAG-TMSI>,

The first part of the temporary ID, GUAMI, may be identical to legacy, the second part TAG-TMSI is autogenerated locally with the known algorithm, which is stored (in memory 212) and executed both in the UE 10 and in the wireless network, respectively stored in memory storage 111 used by the AMF. Thereby the 5GTAG-GUTI does not need to be sent from the AMF to the UE every time it is changed, eliminating the signaling associated with the new temporary ID exchange. The AMF may be configured to distinguish the suggested TAG-TMSI temporary ID address space from regular 5G-TMSI temporary ID address space used for regular UEs, e.g. by identification of a particular UL NAS message type, or an indicator in the NAS message that the NAS message is sent by a UE type operating under a particular power constraint, such as being a passive UE, or that the AMF is specifically configured to only handle such UE types.

There are different known types of algorithms that may be used in the proposed solution. It shall be noted that the specific character of the algorithm is not decisive for the context of the present solution. Nevertheless, it may be noted that in some examples, the algorithm is a pseudorandom number generator (PRNG), also known as a deterministic random bit generator (DRBG), which is an algorithm for generating a sequence of numbers whose properties approximate the properties of sequences of random numbers. The sequence may be completely determined by an initial value, called a seed, which as such may include truly random values. A PRNG suitable for cryptographic applications may be called a cryptographically-secure PRNG (CSPRNG).

According to some examples, the algorithm may be an RSA (Rivest-Shamir-Adleman) algorithm, which involves a public key and private key, wherein the private key is kept secret in both the UE 10 memory 212 and in the wireless network memory 111. Yet another example is an Elliptic Curve Digital Signature Algorithm (ECDSA), wherein an agreement is shared between the UE 10 and the wireless network on curve parameters (CURVE, G, n). Herein, in addition to the field and equation of the curve, a base point G of prime order on the curve is required, where n is the multiplicative order of the point G.

According to one example, there is only one algorithm as specified to employ, in the UE and the wireless network, respectively. The algorithm may in such a case be predetermined, by specification. In other examples, there may be several specified algorithms, and in such case the algorithm needs to be identified. In some examples, this involves the UE 10 receiving a message from the wireless network, identifying said algorithm. Identification of the algorithm may be conveyed in the very first poll message together with a seed, or another message before the seed is received when the UE is registered. This may form part of a registration process. The algorithm may further be negotiated during the registration, as described. In such a process, the wireless network 100 may propose an algorithm, such as a strongest and/or newest, wherein the UE 10 may or may not accept the algorithm if it supports or does not support it. In case the UE does not accept the algorithm, the wireless network 100 may propose another, older and/or less strong, algorithm until the UE 10 accepts one that it supports.

Various examples of the process for further managing temporary IDs after registration according to the proposed solution will now be described with reference to FIGS. 5A and 5B.

FIG. 5A shows a signaling diagram illustrating the general steps according to one aspect of the proposed solution, which involves a method carried out in the UE 10 for managing temporary IDs for use in communication with the wireless network 100, and a complementary method carried out in the wireless network 100. It may be noted that FIG. 5A makes reference to the shorter term TAG. In some examples, this may comprise the 5GTAG-GUTI as described, and in some examples only the TAG TMSI.

FIG. 5A shows a scenario where a TAGₙ is identified as the current ID (TAG_{currentUE} in the UE 10, which current ID is a generated output of iteration n of the algorithm which is locally stored and executed in the UE 10. Meanwhile, the same TAGₙ is identified as the current ID (TAG_{currentNW}) in the wireless network 100, e.g. in memory 111. Here, the current ID is a generated output of iteration n of the algorithm which is locally stored in memory 111 in the wireless network and executed or obtained by the AMF in the wireless network 100.

Going forward, reference will be made to inter alia first and second iterations of the algorithm. This shall not be construed as limited to the very first and second iteration of predetermined sequence. Rather, these terms are merely used to identify that the second iteration follows next after the first iteration. In this context, the first iteration of the algorithm may be identified as any iteration n, generating the output TAGₙ, whereas the second iteration of the algorithm may be identified as iteration n+1,generating the output TAGₙ₊₁. From the viewpoint of the UE 10, the method comprises the following:

The UE 10 receives 510 a poll message 51, comprising a first temporary ID from the wireless network, i.e. TAGₙ which is stored in the wireless network 100 as the current ID.

The UE 10 transmits 540 an uplink message 52 to the wireless network in response to the poll message. This is carried out responsive to the received first temporary ID matching a stored current ID TAG_{currentUE} obtained by a first iteration in the UE of an algorithm configured to iteratively generate temporary IDs. This may be determined 520 based on a lookup test of the locally generated value TAG_{currentUE} and comparing it to the received value TAGₙ.

The UE 10 subsequently stores 550 a second temporary ID TAGₙ₊₁ as the current ID, wherein the second temporary ID is an output of a second iteration of the algorithm in the UE next after said first iteration.

The proposed solution thus involves verifying communication by comparing a received temporary ID with a locally generated temporary ID, and iterating the algorithm to produce a new temporary ID. Successively generated temporary IDs are obtained by iterating a locally stored algorithm, for use in successive polling procedures.

According to one example, the generation of the TAGₙ in the UE 10, and potentially in the wireless network 100, is carried out within the context of a previous polling procedure. This way, the TAGₙ is already stored and available in the UE 10 upon receiving the poll message 51. This is identified by the top box 500 in the drawing, wherein the TAGₙ was obtained in a corresponding step 530 of the preceding polling procedure, and stored as TAG_{currentUE} in step 550 of that preceding polling procedure.

According to another example, identified by the dashed boxes 531 and 532 rather than 530, the generation of the TAGₙ in the UE 10, and potentially in the wireless network 100, is carried out within the current polling procedure. In the drawing, the generation is identified by box 531, whereas box 532 provides that TAGₙ is identified as TAG_{currentUE}. This generation of TAGₙ may be triggered by the reception of the poll message 51, and powered by the RF energy of the poll message 51 where the UE 10 is a passive, energy-harvesting. TAG UE 10. In this example, the method may thus comprise generating 531, responsive to receiving the poll message 51, a new temporary ID TAG_{new} by executing the first iteration of the algorithm, wherein TAG_{new}=TAGₙ. and storing 532 the new temporary ID as the current ID. The determination 520 may nevertheless be based on a lookup test of the locally generated value TAG_{currentUE} and comparing it to the received value TAGₙ. In this example, step 550 of storing ID TAGₙ₊₁ as the current ID forms part of corresponding step 531 of the next polling procedure after the current polling procedure.

According to a related aspect, a UE 10 is provided, comprising a wireless transceiver 213 for communicating with a wireless network 100, and logic circuitry 210 configured to control the UE 10 to carry out the method above, and in various examples also any of the methods proposed herein.

From the viewpoint of the wireless network 100, the method comprises the following, which may be carried out in or under control of the AMF:

The wireless network 100 obtains 505 a temporary first ID TAGₙ, stored 501 as a current ID indicative of the UE, wherein the temporary first ID is an output of a first iteration of an algorithm in the wireless network, which algorithm is configured to iteratively generate temporary IDs.

The wireless network executes transmission 515 of a poll message 51 comprising the first ID, for receipt by the UE 10.

An uplink message 52 is received 535 in the wireless network 100 from the UE 10 in acknowledgment of the poll message 51.

Based on the uplink message 52, a second temporary ID TAGₙ₊₁ is stored 555 as the current ID, wherein the second temporary ID is an output of a second iteration of the algorithm in the wireless network next after said first iteration.

According to the proposed solution, the polling thus triggers the storing of a next iteration n+1 output of the algorithm, individually operated locally in the UE 10 and in the wireless network 100, as the current temporary ID for use in the next polling procedure, or in the current polling procedure. The next current ID is thus determined without requiring additional communication, which saves energy for the UE and network resources. This may comprise saving signaling resources. Moreover, in the case of a passive UE 10 configured for RF power harvesting, the power burst can be switched off early, meaning that a short polling duration can be obtained.

In some examples, a network node of the wireless network is provided, comprising a communication interface for communicating with the UE through the wireless network, such as through the RAN 120, and logic circuitry configured to control the network node to carry out the steps of the methods proposed herein as carried out in the wireless network. The network node may be a core network node, configured to carry out the functions of the AMF. The network node may comprise one or several separate physical units. The logic circuitry may comprise a processing device, including one or multiple processors, microprocessors, data processors, co-processors, and/or some other type of component that interprets and/or executes instructions and/or data. The logic circuitry may further include memory storage, which may include one or multiple memories configured for holding computer program code, which may be executed by the processing device, wherein the logic circuitry is configured to control the network node to carry out any of the method steps as provided herein.

In some examples, generation 530, 531 of a new temporary ID, such as a new TAG-TMSI, is performed every time the UE 10 is polled by the network 100 to send uplink data. Specifically, for a passive UE, or TAG UE, energy conveyed in the DL is harvested in the UE 10 and used to generate a new temporary ID in the UE 10. While the drawing indicates that the new temporary ID is generated after verifying 520 that received first temporary ID matches the stored current ID in the UE, the process is configured differently in some examples. In some realizations of such examples, the new temporary ID is generated 530, 531 in conjunction with reception of the poll message 51, while using RF energy harvested from the received poll message, or a received from continuous transmitted prior to the poll message from the wireless network 100. In some examples, the new temporary ID is only generated responsive to positive outcome of the UE 10 determining that the received first temporary ID TAGₙ actually matches the stored current ID TAG_{currentUE}. In yet another alternative example, the new temporary ID is generated after transmitting 540 the UL acknowledgment message 52, which identifies positive outcome of the UE 10 determining that the received first temporary ID TAG, matched the stored current ID TAG_{currentUE}.

Correspondingly, a new temporary ID is in some examples generated 545 in the wireless network 100 only responsive to receiving the UL acknowledgment message 52, which identifies positive outcome of the UE 10 determining that the received first temporary ID TAGₙ matched the stored current ID TAG_{currentUE}. In alternative examples, the new temporary ID may be generated 545 earlier, such as upon triggering transmission 515 of the poll message 51. In such examples, the new temporary ID may thus already be generated 545 before receiving the UL message 52, even though storing 555 the second temporary ID TAGₙ₊₁, e.g. the new temporary ID, as the current ID is carried out later, responsive to receiving the UL message 52.

In various examples, the current temporary ID is sent in plaintext in DL 51 and potentially also in UL 52, according to legacy behavior. The UL transmission 52 may further comprise data, in response to the poll message 51. In order to ensure proper and secure communication, in DL and/or UL, wherein the receiving node can determine that a message is received from a trusted sending node, mechanisms for handling integrity and ciphering may be employed. In the broad presentation of the proposed solution according to FIG. 5A, this is not considered, and may be taken care of by any known method. In such an example, the new temporary IDs TAG_{new}, which is generated 530, 555 in the UE 10 and in the wireless network 100, may be the second temporary ID TAGₙ₊₁, which will be used as the current ID for the next polling procedure. In the alternative example, as outlined above, the new temporary ID TAG_{new}, which is generated 531 in the UE 10, may be the second temporary ID TAGₙ₊₁

As outlined above, the auto-generated part TAG-TMSI is the Unique Identifier of the UE in the AMF. The current size of 5G-TMSI is 32 bit long, providing an address space of 2³²−1=4 294 967 295 identities per AMF. Even if the likelihood that two UEs would autogenerate the same temporary ID is very low, this needs to be considered. Two options may be considered: either trigger a new ID generation; or resolve the ID collision by performing an integrity protection check of the message, where only one of the devices will pass the integrity check. In the following, further solutions are discussed where temporary IDs, generated in both the UE 10 and the wireless network 100, are further employed for such purposes. This will basically mean that the UE 10 is uniquely identified by a pair of temporary IDs, such as a pair of TAG-TSMI. That would decrease the chances of collision by 4294967295x4294967295.

FIG. 5B shows a signaling diagram illustrating the general steps according to such a modified aspect of the proposed solution, wherein further features are shown which add further security to the communication in addition to the examples provided in FIG. 5A. Like reference numerals are used as in FIG. 5A, for the sake of consistency. The solution involves a method carried out in the UE 10 for managing temporary IDs for use in communication with the wireless network 100, and a complementary method carried out in the wireless network 100. Again, FIG. 5B makes reference to the shorter term TAG. In some examples, this may comprise the 5GTAG-GUTI as described, and in some examples only the TAG TMSI.

With reference to the foregoing, and as exemplified in FIG. 5A, the wireless network 100 polls the UE 10 with the current TAG-TMSI and the UE sends the UL data using the current TAG-TMSI as the source ID. Obviously this may, as such, not be considered to provide ample security, considering the risk that the current TAG-TMSI sent in clear text in the DL may be picked up and used by a “rouge” UE in response. It is an important factor to ensure that both the UE 10 know that it is polled by a trusted network node (AMF), and that the network 100 can trust that the UL data is sent by a UE 10 that has a subscription with the operator-that the correct UE is polled. This relates to the mentioned feature of ensuring integrity, and as mentioned the UE 10 and network 100 can use the same security methods as already specified in previous 3GPP releases, i.e. exchange security parameters and keys during the initial registration procedure's security message exchange. This involves extensive handshaking and transmission of a large number of parameters. Specifically, such procedures may be difficult for a UE that is only powered by RF harvesting when polled by the network.

With this in mind, a solution for adding security without adding too much complexity is proposed, as described by way of example in FIG. 5B. In short, the next temporary ID, e.g. TAG-TMSI, in the iteration sequence of the algorithm is used to at least integrity protect the DL poll and the UL data message. In other words, a “next to be current” temporary ID that has not yet been used as the current ID over the air yet. This may comprise adding a hash of the next temporary ID in conjunction with the clear text representation of the current ID. To further protect the data in the UL the next temporary ID could be used as a key when encrypting the message, i.e., serving as a secret input to the cryptographic algorithm.

Referring again to FIG. 5B, TAGₙ is stored as current ID (TAG_{currentUE} in the UE 10, which current ID is a generated output of iteration n of the algorithm which is locally stored and executed in the UE 10. The same TAGₙ is stored as the current ID (TAG_{currentNW}) in the wireless network 100, e.g. in memory 111. Here, the current ID is a generated output of iteration n of the algorithm which is locally stored in memory 111 in the wireless network and executed or obtained by the AMF in the wireless network 100.

Moreover, a second temporary ID TAGₙ₊₁ is stored in memory 212 as a next ID (TAGₙₑₓₜ), wherein the secondary ID is an output of a second iteration of the algorithm in the UE next after said first iteration. Correspondingly, the second temporary ID TAGₙ₊₁ is stored in memory 111 as a next ID (TAGₙₑₓₜ) in the wireless network, wherein the secondary ID is an output of a second iteration of the algorithm in the wireless network next after said first iteration. In various examples, the stored temporary IDs TAGₙ and TAGₙ₊₁ were generated in the UE 10 and in the wireless network 100 in the context of previous polling procedures. Specifically, in some examples, in a polling procedure in which a TAGₙ is used as the current ID, the n+2 iteration is generated by locally running the algorithm in the UE 10 and in the wireless network 100, while the n+1 iteration of the temporary ID is already available from storage since the nearest preceding polling procedure.

From the viewpoint of the UE 10, the method outlined in FIG. 5B thus comprises the following:

The UE 10 receives 510 a poll message 61, comprising a first temporary ID from the wireless network, i.e. TAGₙ which is stored in the wireless network 100 as the current ID.

The UE 10 transmits 540 an uplink message 62 to the wireless network in response to the poll message. This is carried out responsive to the received first temporary ID matching a stored current ID TAG_{currentUE} obtained by a first iteration in the UE of an algorithm configured to iteratively generate temporary IDs, and based on checking an integrity of the poll message 61 by using a second ID, wherein the second temporary ID is an output of a second iteration of the algorithm in the UE next after said first iteration. Determining 520 that the received first temporary ID matches a stored current ID TAG_{currentUE} may be made based on a lookup test of the stored value TAG_{currentUE} and comparing it to the received value TAGₙ. The method may further comprise checking 521 an integrity of the poll message by identifying an integrity protection of the poll message as matching the second ID, which is stored as TAGₙₑₓₜ in the UE 10.

In some examples, the UE 10 integrity-protects 541 the uplink message 62 by using the second ID as part of a hash function or other integrity protection function. Alternatively, the UE may integrity-protect the uplink message 62 with a hash function that does not use the second ID. Where the UE 10 transmits data in the UL message 62, the UE 10 is in some examples further configured to encrypt 542 the data based on the second ID, and transmit the encrypted data in said uplink message.

The UE 10 subsequently stores 550 the second temporary ID TAGₙ₊₁ as the current ID.

From the viewpoint of the wireless network 100, the method comprises the following, which may be carried out in or under control of the AMF:

The wireless network 100 obtains 505 a temporary first ID TAGₙ, stored as a current ID indicative of the UE, wherein the temporary first ID is an output of a first iteration of an algorithm in the wireless network, which algorithm is configured to iteratively generate temporary IDs.

The wireless network executes transmission 515 of a poll message 61 comprising the first ID, for receipt by the UE 10, wherein the poll message 61 is integrity-protected 514 using a second temporary ID TAGₙ₊₁, wherein the second temporary ID is an output of a second iteration of the algorithm in the wireless network next after said first iteration.

An uplink message 62 is received 535 in the wireless network 100 from the UE 10 in acknowledgment of the poll message 61.

The wireless network 100 may be configured to check 536 the integrity of the message 62, using the stored secondary ID.

Based on the uplink message 62 passing the integrity check 536, the temporary ID TAGₙ₊₁ is stored 555 as the current ID for the next polling procedure. It will thus be understood that in a next polling procedure, wherein the n+1 iteration of the temporary ID is applied as the current ID, the n+2 iteration of the temporary ID is used for integrity protection/checking, and/or for ciphering/deciphering.

According to the proposed solution, the polling thus triggers the storing of a next iteration n+1 output of the algorithm, individually operated locally in the UE 10 and in the wireless network 100, as the current temporary ID for use in the next polling procedure. The next current ID is thus determined without requiring additional communication, which saves energy for the UE and network resources.

In some examples, generation 530 of a new temporary ID, such as a new TAG-TMSI, is performed every time the UE 10 is polled by the network 100 to send uplink data. Specifically, for a passive UE, or TAG UE, energy conveyed in the DL is harvested in the UE 10 and used to generate a new temporary ID in the UE 10. In some realizations of such examples, the new temporary ID is generated 530 in conjunction with reception of the poll message 61, while using RF energy harvested from the received poll message, or energy received from an RF signal transmitted prior to the poll message from the wireless network 100, e.g. a transmitted continuous wave signal. In some examples, the new temporary ID is only generated responsive to a positive outcome of the UE 10 determining that the received first temporary ID TAG, actually matches the stored current ID TAG_{currentUE} and responsive to a successful integrity-check based on the second ID. In yet another alternative example (not shown), the new temporary ID is generated after transmitting the UL acknowledgment message 62. which identifies a positive outcome of the UE 10 determining that the received first temporary ID TAGₙ matched the stored current ID TAG_{currentUE}.

Correspondingly, a new temporary ID is in some examples generated 545 in the wireless network 100 only responsive to receiving the UL acknowledgment message 62, which identifies positive outcome of the UE 10 determining that the received first temporary ID TAGₙ matched the stored current ID TAG_{currentUE}, and based on successfully integrity-checking 536 the UL message 62.

Where data is received 535 in the UL response message 62, and the data is encrypted as outlined, the wireless network 100 is configured to decrypt 565 the data using the stored second temporary ID TAGₙ₊₁.

According to one aspect, the UE 10 must be registered to the wireless network 100. This may involve the network 100 identifying contact with the UE 10 and identifying the common algorithm to employ as local identical versions in the UE 10 and in the wireless network, respectively.

In some examples, the UE may be registered by receiving a synchronization message from the wireless network, comprising a seed for use as input to the algorithm to generate a temporary ID in the UE.

The UE 10 is thereby configured to generate an initial temporary ID indicative of the UE by executing the algorithm stored in the UE using said seed, and to store the initial temporary ID as the current ID.

The UE 10 then transmits an acknowledgment message to the wireless message, to trigger storage in the wireless network of the initial temporary ID as generated using the local copy of the algorithm in the wireless network.

The wireless network 100, such as the AMF, may on the other hand operate a corresponding procedure:

An initial temporary ID indicative of the UE 10 is generated by executing the algorithm stored in the wireless network using a specific seed.

A synchronization message is transmitted from the wireless network, comprising said seed to the UE, to trigger the UE to generate the initial temporary ID using its local copy of the algorithm in the UE.

The wireless network receives an acknowledgment message from the UE 10 in response to the synchronization message, and stores, based on the acknowledgment message, the specific temporary ID as the current ID.

According to various examples of the proposed solution, a new temporary ID generation is triggered every time the UE 10 is polled by the wireless network 100 and sends UL data. Nevertheless, it is still possible that either the UE 10 or the AMF loses synch, e.g. such that the TAG_{currentUE} does not match the TAG_{currentNW}, due to them being the output of different iterations of the common algorithm. For this purpose, a recovery process is proposed. According to one example, the recovery process includes “re-registration” with the wireless network 100 based on the registration process described above. However, before re-registration is performed the AMF is in some examples configured to check N steps backwards or forwards to attempt to re-synch with the UE, i.e. recent previous or next iterations of the algorithm. In one example, the wireless network is configured to, responsive to not obtaining an UL response message 52, 62 in response to a poll message, change the current ID in the wireless network (TAG current NW) obtained as output of an iteration k to the output of an iteration k+x, where x is iteratively selected and used in a DL poll message 51, 61 according to a predetermined schedule until a poll response message 52, 62 is obtained or the sequence ends. In this context, x may follow a sequence of both positive and negative numbers (e.g. [1, −1, 2, −2, 3, −3], only negative (e.g. [−1, −2, −3], or only positive (e.g. [1, 2, 3]).

There are many ways how the auto-generation and synchronisation can be done, one way is that the AMF provides a new “seed” to the ID generation algorithm, the UE acknowledges the receipt of the new seed and the two entities have recovered and are in synch.

From the perspective of the UE 10, a process for re-synchronizing a UE with the wireless network may comprise the steps of:

receiving a synchronization message from the wireless network;

generating a specific temporary ID in the UE based on the synchronization message;

storing the specific temporary ID as the current ID;

transmitting an acknowledgment message to the wireless message, to trigger storage in the wireless network of the specific temporary ID as generated using a local copy of the algorithm in the wireless network.

As exemplified, the synchronization message may be indicative of a new seed for input to the algorithm, or indicative of a specific iteration of the algorithm.

Various aspects of the proposed solution have been described in the foregoing. Unless where clearly contradictory, the features of any example provided herein may be combined in any way, including any combination of the items set out below.

Item 1. A method carried out in a User Equipment (10), UE, for transmission of data to a wireless network (100), the method comprising:

receiving (412) a poll message (41) from a relay device (20), which poll message identifies a request for data transmission to the wireless network;

transmitting (414) a Non-Access Stratum, NAS, message (42) in response to the poll message, said NAS message comprising a protocol data unit, PDU, including the data, and a temporary ID for the UE to address a core network node in the wireless network, wherein the relay device is instructed to forward the NAS message to the wireless network.

Item 2. The method of item 1, wherein a forwarding indicator is transmitted with the NAS message (42).

Item 3. The method of item 1 or 2, wherein the NAS message is transmitted on a carrier reflection of a carrier conveying the poll message.

Item 4. The method of any preceding item, comprising:

harvesting (413) radio-frequency energy obtained upon receiving the poll message;

wherein the NAS message is transmitted using the harvested energy.

Item 5. The method of any preceding item, wherein the poll message comprises a recipient ID identifying said UE.

Item 6. The method of item 5, wherein the recipient ID comprises said temporary ID. Item 7. The method of item, wherein the recipient ID indicates a UE group or UE type to which the said UE belongs.

Item 8. The method of any preceding item, wherein the temporary ID is a current ID obtained by a first iteration in the UE of an algorithm configured to iteratively generate temporary IDs, wherein the method further comprises:

storing (550) a second temporary ID (TAGn+1) as the current ID, wherein the second temporary ID is an output of a second iteration of the algorithm in the UE next after said first iteration.

Item 9. The method of any of items 1-7, wherein the temporary ID comprises a Temporary Mobile Subscriber Identity, 5G-TMSI or 5G-S-TMSI.

Item 10. The method of any preceding item, wherein the core network node is an Access and Mobility Management Function (AMF).

Item 11. A User Equipment (10), UE, comprising:

a wireless transceiver (213); and

logic circuitry (210) configured to control the UE to carry out the steps of any of items 1-10.

Item 12. The UE of item 11, further comprising:

a harvesting module (216), configured to harvest radio frequency energy obtained from a received downlink signal from the wireless network, wherein the wireless transceiver and the logic circuitry are powered by the harvesting module.

Item 13. A method carried out in a relay device (20) for conveying data from a User Equipment (10), UE, to a wireless network (100), the method comprising: transmitting (411) a poll message, which poll message identifies a request for data transmission to the wireless network;

receiving (415), in response to the poll message, a Non-Access Stratum, NAS, message from the UE, wherein the NAS, message comprises a protocol data unit, PDU, including the data, and a temporary ID for the UE to address a core network node in the wireless network; and

transmitting (417), based on an indication to forward the NAS message, a signaling packet (43) comprising the NAS message to the wireless network.

Item 14. The method of item 13, wherein transmitting the signaling packet (43) is carried out responsive to a forwarding indicator being received with the NAS message (42).

Item 15. The method of item 13, wherein transmitting the signaling packet (43) is carried out responsive to receiving the NAS message (42) in response to the poll message.

Item 16. The method of any of items 13-15, wherein the poll message is transmitted on a carrier, and wherein the NAS message is received on a carrier reflection of said carrier.

Item 17. The method of any of items 13-16, wherein transmitting the signaling packet to the wireless network is carried out without changing connectivity status of the relay device to the wireless network.

Item 18. The method of any of items 13-17, wherein the signaling packet is transmitted in idle mode connectivity state of the relay device to the wireless network.

Item 19. The method of any of items 13-18, wherein the signaling packet is transmitted in a message on a random access channel, RACH.

Item 20. A wireless device, comprising:

a wireless transceiver (233); and

logic circuitry (230) configured to control the wireless device to operate as a relay device according to the steps of any of items 13-19.

1. A method carried out in a User Equipment (UE) for transmission of data to a wireless network, the method comprising:
receiving a poll message from a relay device, which poll message identifies a request for data transmission to the wireless network;
transmitting a Non-Access Stratum (NAS), message in response to the poll message, said NAS message comprising a protocol data unit (PDU), including the data, and a temporary ID for the UE to address a core network node in the wireless network, wherein the relay device is instructed to forward the NAS message to the wireless network.

2. The method of claim 1, wherein a forwarding indicator is transmitted with the NAS message.

3. The method of claim 1, wherein the NAS message is transmitted on a carrier reflection of a carrier conveying the poll message.

4. The method of claim 1, comprising:
harvesting radio-frequency energy obtained upon receiving the poll message;
wherein the NAS message is transmitted using the harvested energy.

5. The method of claim 1, wherein the poll message comprises a recipient ID identifying said UE.

6. The method of claim 5, wherein the recipient ID comprises said temporary ID.

7. The method of claim 1, wherein the recipient ID indicates a UE group or UE type to which the said UE belongs.

8. The method of claim 1, wherein the temporary ID is a current ID obtained by a first iteration in the UE of an algorithm configured to iteratively generate temporary IDs, wherein the method further comprises:
storing a second temporary ID as the current ID, wherein the second temporary ID is an output of a second iteration of the algorithm in the UE next after said first iteration.

9. The method of claim 1, wherein the temporary ID comprises a Temporary Mobile Subscriber Identity, 5G-TMSI or 5G-S-TMSI.

10. The method of claim 1, wherein the core network node is an Access and Mobility Management Function (AMF).

11. A User Equipment (UE) comprising:
a wireless transceiver; and
logic circuitry configured to control the UE to carry out the steps of claim 1.

12. The UE of claim 11, further comprising:
a harvesting module, configured to harvest radio frequency energy obtained from a received downlink signal from the wireless network, wherein the wireless transceiver and the logic circuitry are powered by the harvesting module.

13. A method carried out in a relay device for conveying data from a User Equipment (UE), to a wireless network, the method comprising:
transmitting a poll message, which poll message identifies a request for data transmission to the wireless network;
receiving, in response to the poll message, a Non-Access Stratum (NAS) message from the UE, wherein the NAS, message comprises a protocol data unit_ (PDU) including the data, and a temporary ID for the UE to address a core network node in the wireless network; and
transmitting, based on an indication to forward the NAS message, a signaling packet comprising the NAS message to the wireless network.

14. The method of claim 13, wherein transmitting the signaling packet is carried out responsive to a forwarding indicator being received with the NAS message.

15. The method of claim 13, wherein transmitting the signaling packet is carried out responsive to receiving the NAS message in response to the poll message.

16. The method of claim 13, wherein the poll message is transmitted on a carrier, and wherein the NAS message is received on a carrier reflection of said carrier.

17. The method of claim 13, wherein transmitting the signaling packet to the wireless network is carried out without changing connectivity status of the relay device to the wireless network.

18. The method of claim 13, wherein the signaling packet is transmitted in idle mode connectivity state of the relay device to the wireless network.

19. The method of claim 13, wherein the signaling packet is transmitted in a message on a random access channel (RACH), RACH.

20. A wireless device, comprising:
a wireless transceiver; and
logic circuitry configured to control the wireless device to operate as a relay device according to the steps of claim 13.
